(19) United States
(12) Patent Application Publication
(10) Pub. No.: US 2012/0125144 A1
(43) Pub. Date: May 24, 2012

(54) Jack Handle Systems

(76) Inventors: Kam Kuen Addy Law, Kowloon (HK); Mark Yueh, Taipei City (TW)

(21) Appl. No.: 13/277,749

(22) Filed: Oct. 20, 2011

Related U.S. Application Data
(60) Provisional application No. 61/405,744, filed on Oct. 22, 2010.

(51) Int. Cl. B66F 13/00

(52) U.S. Cl. 74/544; 74/543

(57) ABSTRACT

Jacks and handle systems for jacks are disclosed. In one embodiment, a jack includes a base, a pivotable handle sleeve, a lifting portion, coupling structure affixed to at least one of the base and the lifting portion, and a first elongate rigid member. The coupling structure defines a passageway extending generally perpendicular to the base and an opening generally perpendicular to the passageway. The first elongate rigid member has proximal and distal ends, and the distal end of the first elongate rigid member is configured to interact with the pivotable handle sleeve to actuate the lifting portion. The distal end is also configured to pass through the passageway and interact with the opening to operatively couple the first elongate rigid member to the lifting portion apart from the pivotable handle sleeve such that the first elongate rigid member extends generally perpendicularly to the base.

### CROSS-REFERENCE TO RELATED APPLICATIONS

This application claims priority to U.S. Provisional Patent Application No. 61/405,744, filed Oct. 22, 2010, which is incorporated herein by reference in its entirety.

### TECHNICAL FIELD

The disclosed subject matter is directed to handles, and in particular to bottle jack handles.

### BACKGROUND

Jacks, including bottle jacks, are well known lifting devices. Exemplary prior art bottle jack 100—an Omega Lift Equipment™ model 10025C bottle jack—is shown in FIG. 1a. A handle assembly 110 is inserted in handle sleeve 120 and pumped to raise the saddle 130. The handle assembly 110 is shown to be removable from the handle sleeve 120 and to have separate portions 112a, 112b, though other prior art bottle jacks have unitary handle assemblies that may or may not be removable from the handle sleeve. FIG. 1b shows the handle assembly 110 assembled and coupled to the handle sleeve 120. The handle sleeve 120 has an opening 124 with an offset portion 124a, and protrusion 114 of the handle assembly 110 extends through the opening 124 and into the offset portion 124a to temporarily lock the handle assembly 110 to the handle sleeve 120 for raising the saddle 130. When the jack 100 is not being used, the portions 112a, 112b of the handle assembly 110 may be separated as shown in FIG. 1a; this may help minimize storage space required for the jack 100, but the handle assembly 110 generally serves no function when separated from the handle sleeve 120.

### SUMMARY

Jacks and handle systems for jacks are disclosed herein. In one embodiment, a handle system for a bottle jack having a base, a handle sleeve, and a lifting portion includes a first elongate rigid member having proximal and distal ends. The distal end of the first elongate rigid member is configured to interact with the handle sleeve to actuate the jack lifting portion. Structure is included for temporarily coupling the first elongate rigid member to the bottle jack apart from the handle sleeve such that the first elongate rigid member extends generally perpendicularly to the jack base and generally parallel to the jack lifting portion.

In another embodiment, a handle system for a bottle jack having a base, a pivotable handle sleeve, and a lifting portion includes coupling structure affixed to at least one of the base and the lifting portion. The coupling structure defines a passageway extending generally perpendicular to the jack base and an opening generally perpendicular to the passageway. A first elongate rigid member is included that has proximal and distal ends. The distal end of the first elongate rigid member is configured to interact with the pivotable handle sleeve to actuate the jack lifting portion. The distal end of the first elongate rigid member is also configured to pass through the passageway and interact with the opening to couple the first elongate rigid member to the bottle jack apart from the pivotable handle sleeve such that the first elongate rigid member extends generally perpendicularly to the jack base.

In still another embodiment, a jack includes a base, a pivotable handle sleeve, a lifting portion, coupling structure affixed to at least one of the base and the lifting portion, and a first elongate rigid member. The coupling structure defines a passageway extending generally perpendicular to the base and an opening generally perpendicular to the passageway. The first elongate rigid member has proximal and distal ends, and the distal end of the first elongate rigid member is configured to interact with the pivotable handle sleeve to actuate the lifting portion. The distal end of the first elongate rigid member is also configured to pass through the passageway and interact with the opening to operatively couple the first elongate rigid member to the lifting portion apart from the pivotable handle sleeve such that the first elongate rigid member extends generally perpendicularly to the base.

### BRIEF DESCRIPTION OF THE DRAWINGS

FIG. 1a is a perspective view of a PRIOR ART bottle jack.

FIG. 1b is a detailed view showing the PRIOR ART handle assembly of FIG. 1 in use.

FIG. 2 is a perspective view of a bottle jack having a handle system according to an embodiment, with the handle system at a use configuration.

FIG. 3a is a perspective view of the bottle jack having the handle system of FIG. 2, with the handle system at a transport configuration.

FIG. 3b is a detailed view from FIG. 3a.

FIG. 4 is a perspective view of part of the handle system of FIG. 2, at the use configuration.

FIG. 5a is a perspective view of part of the handle system of FIG. 2, at the transport configuration.

FIGS. 5b and 5c are detailed views of the handle system configured as shown in FIG. 5a.

FIG. 6 is a perspective view of the connection member of the handle system of FIG. 2.

FIG. 7 is a perspective view of the grip member of the handle system of FIG. 2.

FIG. 8a shows a bottle jack having a handle system according to another embodiment, with the handle system at a transport configuration.

FIG. 8b shows the bottle jack having the handle system of FIG. 8a, at an intermediate configuration.

FIG. 8c is a perspective view of the bottle jack having the handle system of FIG. 8a, with the handle system at a use configuration.

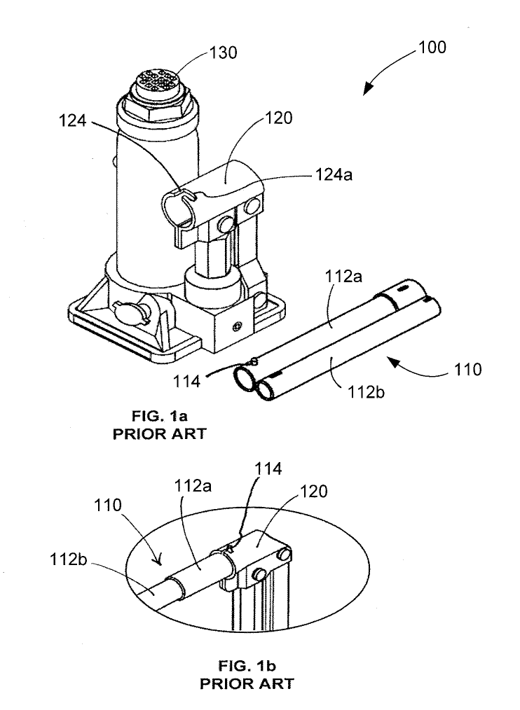

### DETAILED DESCRIPTION

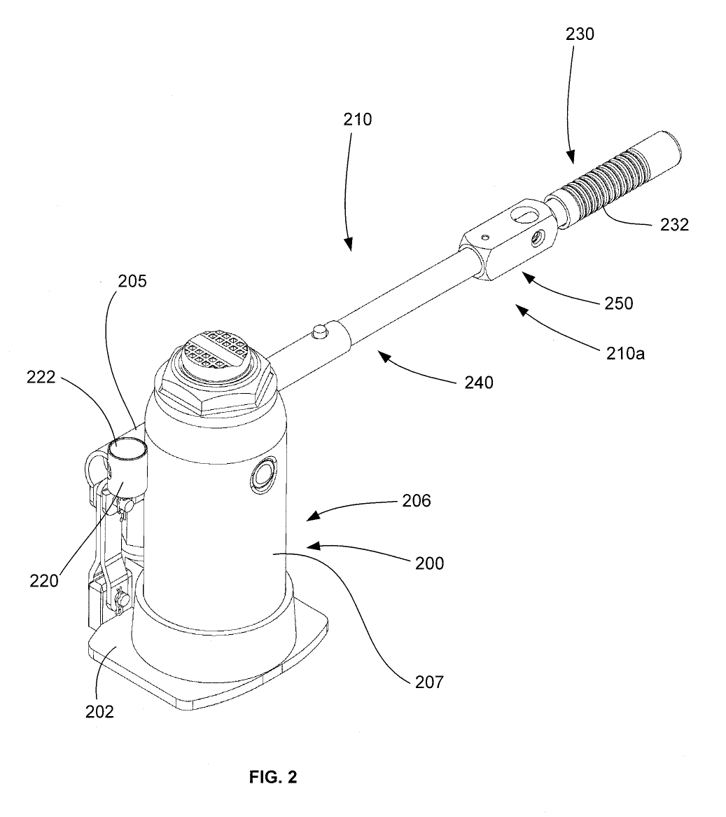

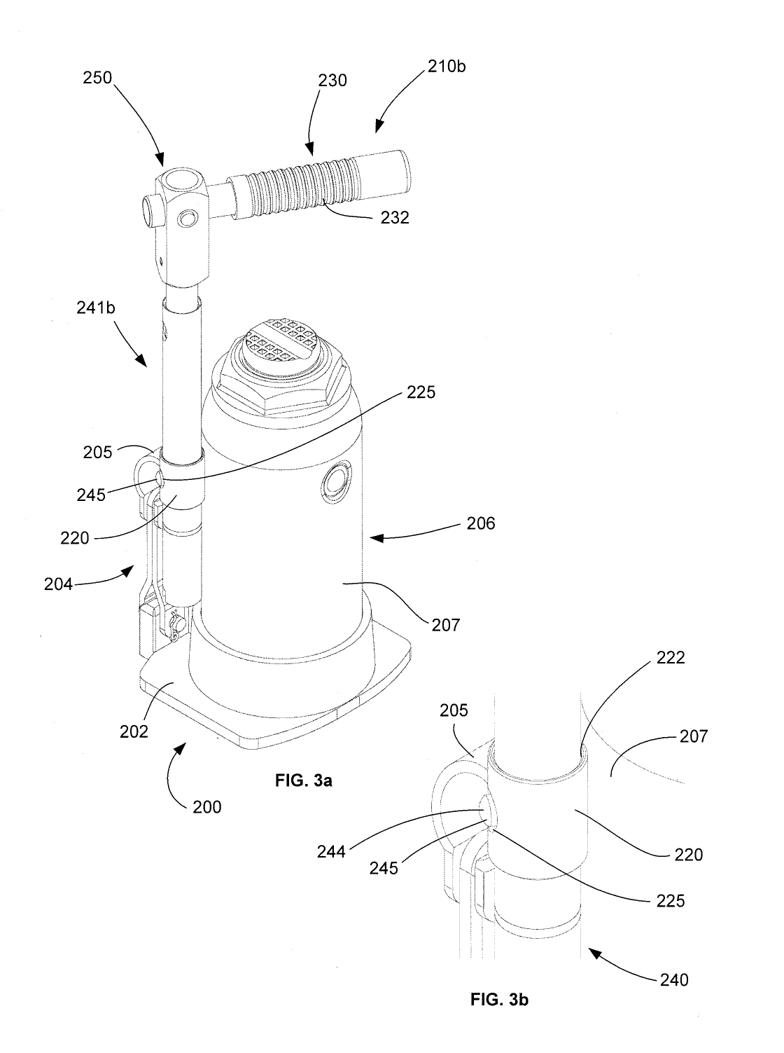

FIGS. 2 through 7 show a bottle jack 200 having a handle system 210 according to one embodiment. The bottle jack 200, apart from the handle system 210, is traditional and includes a base 202, an input portion 204 with a handle sleeve 205 extending from the base 202, and a lifting portion 206 extending from the base 202. The lifting portion 206 has an outer wall 207. Though not shown, those skilled in the art will appreciate that the bottle jack 200 may be an “in-line” bottle jack (i.e., such that the input portion 204 is rotated ninety degrees to the configuration shown in FIG. 3), such as for example an Omega Lift Equipment™ model 10120 bottle jack.

Focus is now directed to the handle system 210, which has a secondary handle sleeve 220, a proximal (or “grip”) member 230, a distal (or “link”) member 240, and a connection member 250. The secondary handle sleeve 220 has an opening 222 and is fixed relative to the bottle jack 200, such as by being welded, bolted, adhered to, formed unitary with, or otherwise attached to the outer wall 207 (as shown in FIGS. 3a and 3b) or the base 202. Though other configurations are possible, it may be desirable for the opening 222 to extend generally perpendicularly from the base 202 (e.g., generally parallel to the lifting portion 206). Moreover, the opening 222 may be a through opening, as shown in FIG. 3b, or may be a cavity that does not fully extend through the secondary handle sleeve 220. Coupling structure 225 in the secondary handle sleeve 220 is complementary to coupling structure 245 in the link member 240, such that the link member 240 may be removably coupled to the secondary handle sleeve 220 as discussed in further detail below.

Various materials may be used to construct the secondary handle sleeve 220, such as metals, composites, and plastics. Considerations in selecting material for the secondary handle sleeve 220 may include, for example, strength of the secondary handle sleeve 220, weight of the bottle jack 200 apart from the handle system 210 (which will, for example, affect the forces acting upon the secondary handle sleeve 220 when the secondary handle sleeve 220 is being used), weight of the secondary handle sleeve 220 (it may, for example, be desirable to minimize the weight of the secondary handle sleeve 220), intended lifespan of the bottle jack 200, intended work environment for the bottle jack 200, and the method of fixing the secondary handle sleeve 220 to the bottle jack 200 (e.g., if welding is used to couple the secondary handle sleeve 220 to the outer wall 207, the material of the secondary handle sleeve 220 must be compatible with the material of the outer wall 207).

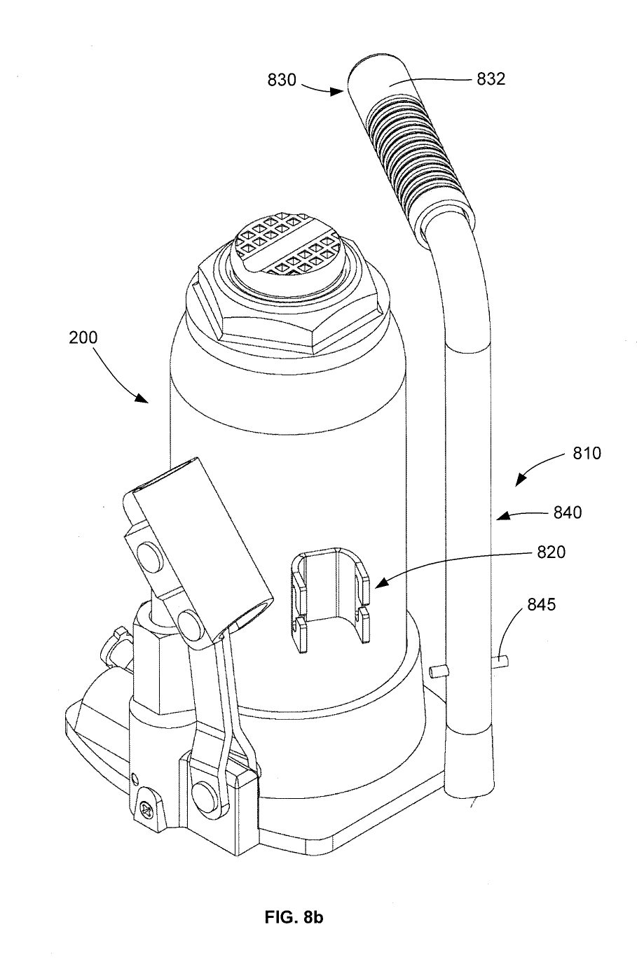

The grip member 230, best shown in FIG. 7, is generally rigid between proximal and distal ends 230a, 230b and may include a generally unitary rigid element 231 (as shown), a telescoping element, or multiple separable elements arranged linearly. A handle 232 is at the proximal end 230a and may overlay the rigid structure of the grip member 230. Coupling structure 235 in the grip member 230 is complementary to coupling structure (e.g., a hole) 259 in the connection member 250, such that the grip member 230 may be removably coupled to the connection member 250 as discussed in further detail below. The coupling structure 235 in the handle system embodiment 210 is a spring biased pin 235.

Various materials may be used to construct the grip member 230. The rigid portion of the grip member 230 may be constructed, for example, of metals, composites, plastics, and wood, and the handle 232 may be constructed, for example, of rubber and rubberized materials. Hollow metal tube, as shown in FIG. 7, may be particularly desirable. Considerations in selecting material for the grip member 230 may include, for example, strength, weight, lifespan, and intended work environment.

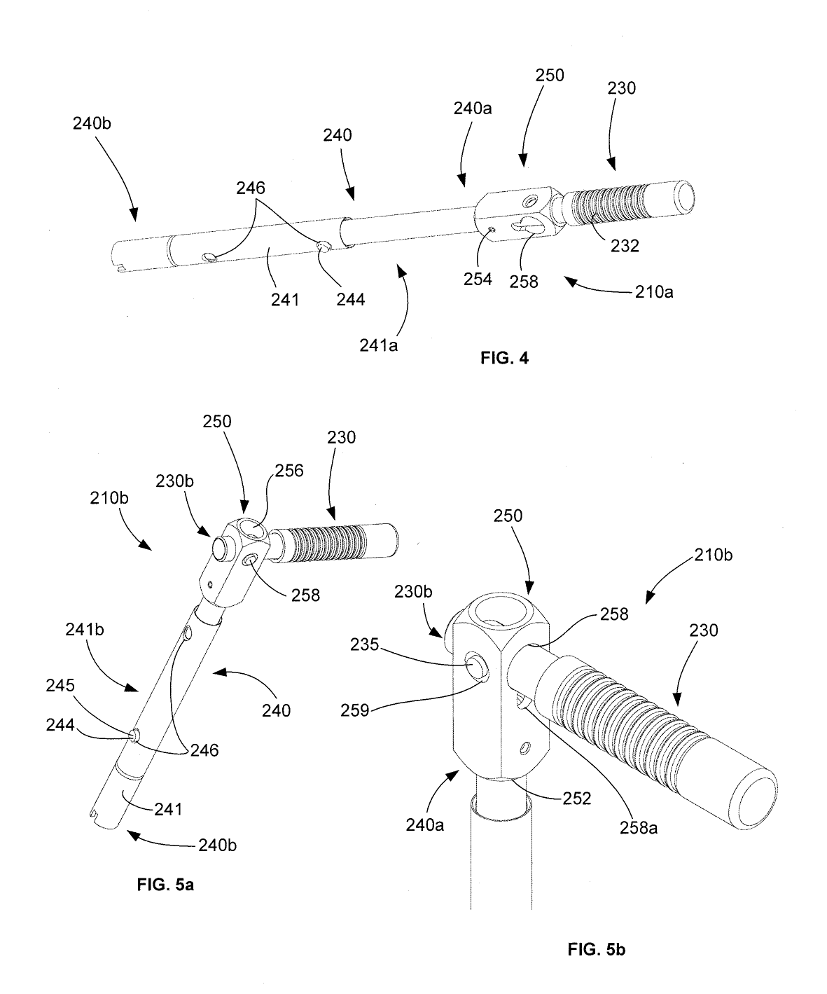

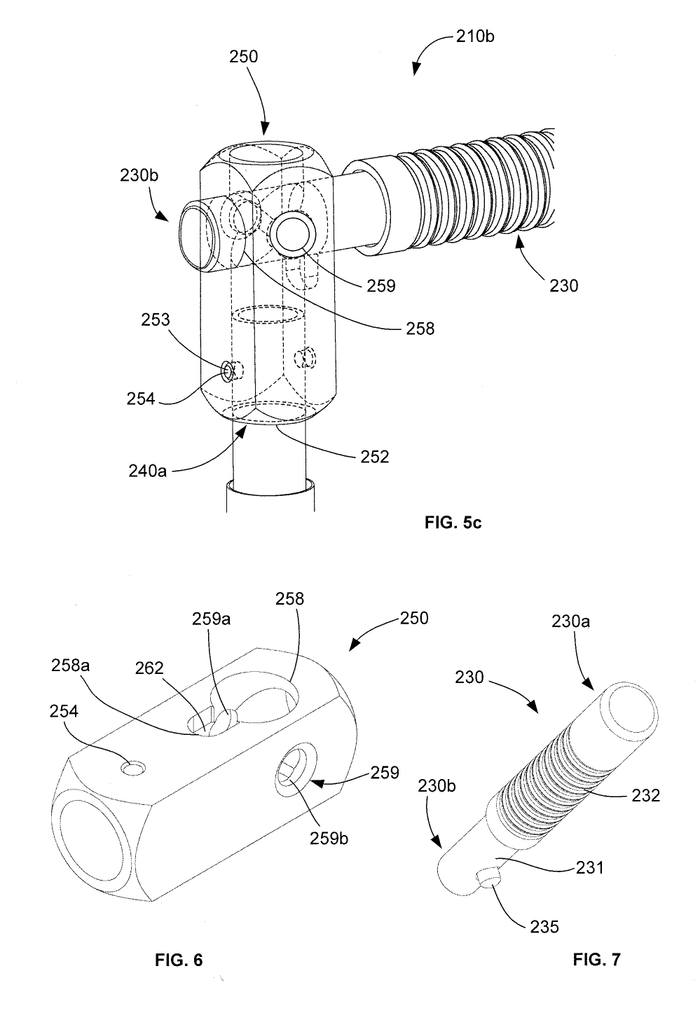

The link member 240, best shown in FIGS. 4 and 5a, is generally rigid between proximal and distal ends 240a, 240b and may include a generally unitary rigid element, a telescoping element 241 (as shown), or multiple separable elements arranged linearly. A spring biased pin 244 respectively interacts with holes 246 to lock the telescoping link member 240 at extended and retracted configurations 241a, 241b (FIGS. 4 and 5a, respectively). In addition, the spring biased pin 244 serves as the coupling structure 245 that is complementary to the coupling structure (e.g., hole) 225 in the secondary handle sleeve 220, as shown in FIGS. 3a and 3b. In different embodiments, other coupling structure 245, 225 may be utilized; however, it may be desirable to use a single pin 244 to both lock telescoping element 241 and couple the link member 240 to the secondary handle sleeve 220.

Various materials may be used to construct the link member 240. The rigid telescoping element 241 may be constructed, for example, of metals, composites, plastics, and wood. Hollow metal tube may be particularly desirable. Considerations in selecting material for the link member 240 may include, for example, strength, weight, lifespan, and intended work environment.

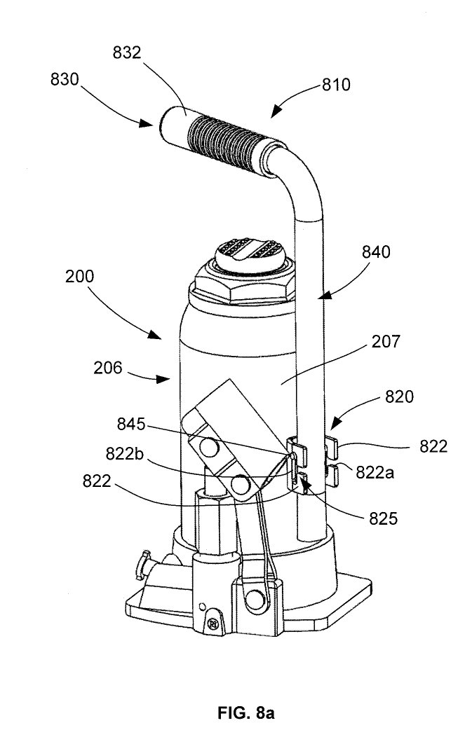

The connection member 250 is shown in detail in FIG. 6 and is used to couple the grip and link members 230, 240 to one another in a generally linear (or “use”) configuration 210a (FIGS. 2 and 4) and an offset (or “transport”) configuration 210b (FIG. 3a and FIGS. 5a through 5c). The connection member 250 may be permanently coupled to either the grip member 230 or the link member 240, or the connection member 250 may be removably coupled to both the grip and link members 230, 240. In the embodiment 210, the connection member 250 has an elongate center axis and a hole 252 extending along, or generally parallel to, the center axis, and the link member proximal end 240a is positioned in the hole 252. Set screws 253 (FIG. 5c), a bolt, a pin, a rivet, or other fasteners pass through holes 254 in the connection member 250 to fix the connection member 250 to the link member proximal end 240a. Welding and adhesives may also, or alternately, be used, or the connection member 250 may be formed unitary with the link member 240.

Hole 256 (FIG. 5a) in the connection member 250 is sized to receive the grip member distal end 230b and extends along, or generally parallel to, the connection member center axis. Hole 258 (FIG. 5a) in the connection member 250 is offset (e.g., generally perpendicularly) to the hole 256, and is also sized to receive the grip member distal end 230b. In addition, the hole 258 includes a keyway 258a sized to receive the spring biased pin 235. The hole 259 is offset (e.g., generally perpendicularly) to both the hole 256 and the hole 258, and may be a through hole having portions 259a, 259b (FIG. 6). A guide (or “ramp”) 262 (FIG. 6) provides a smooth path from the keyway 258a to the hole 259, such that when the spring biased pin 235 of the grip member 230 passes through the keyway 258a and the grip member 230 is rotated, the guide 262 causes the pin 235 to retract until reaching the hole 259. If both hole portions 259a, 259b are included, the grip member 230 may be rotated either clockwise or counter-clockwise after the pin 235 is inserted through the keyway 258a.

Various materials may be used to construct the connection member 250. The connection member 250 may be constructed, for example, of metals, composites, plastics, and wood. Considerations in selecting material for the grip member 230 may include, for example, strength, weight, lifespan, and intended work environment.

To use the bottle jack 200, the grip and link members 230, 240 are coupled in the use configuration 210a, as shown in FIGS. 2 and 4. More specifically, the pin 235 is retracted and the grip member distal end 230b is moved through the hole 256 and positioned inside the connection member 250 with the pin 235 interacting with the hole 259. The link member distal end 240b interacts with the handle sleeve 205, the telescoping link member 240 is moved to the extended configuration 241a (FIG. 4), and the user holds the handle 232 and pivots the grip and link members 230, 240 about the handle sleeve 205 to activate the bottle jack 200.

To transport the bottle jack 200, the grip and link members 230, 240 are disengaged from the use configuration 210a (i.e., by retracting the pin 235 and removing the grip member distal end 230b from the hole 256) and coupled in the transport configuration 210b, as shown in FIG. 3a. More specifically, the grip member distal end 230b is moved through the hole 258 with the pin 235 passing through the keyway 258a, the grip member 230 is then rotated, and the guide 262 causes the pin 235 to retract until reaching the hole 259—where interaction between the pin 235 and the hole 259 temporarily locks the grip member 240 to the connection member 250 (and thus the link member 240). The link member distal end 240b is coupled to the secondary handle sleeve 220 (e.g., by interaction between the coupling structure 225 in the secondary handle sleeve 220 and the coupling structure 245 in the link member 240), and the bottle jack 200 may be carried by the handle 232. If desired, the telescoping link member 240 may be moved to the retracted configuration 241b (FIGS. 3a and 5a).

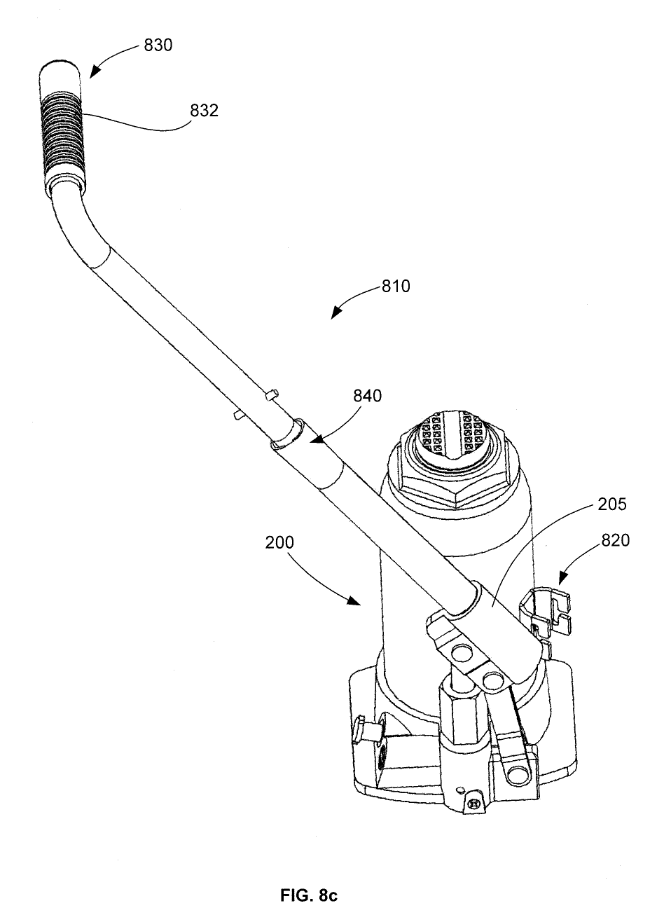

In another embodiment, the bottle jack 200 has a handle system 810, as shown in FIGS. 8a through 8c. The bottle jack 200 may be the same as shown in FIGS. 2 and 3a and described above, and the handle system 810 is similar to the handle system 210 in various aspects. The handle system 810 includes a handle support 820, a proximal (or “grip”) member 830, and a distal (or “link”) member 840.

The handle support 820 includes a pair of walls 822 spaced apart and extending generally parallel to one another. The walls 822 are spaced apart sufficiently such that the link member 840 may be positioned between the walls 822. Coupling structure 825 in the handle support 820 is complementary to coupling structure 845 in the link member 840, such that the link member 840 may be removably coupled to the handle support 820. For example, each wall 822 includes an access opening 822a that leads to a channel 822b that extends to both sides of the access opening 822a. The handle support 820 is fixed relative to the bottle jack 200, such as by being welded, bolted, adhered to, formed unitary with, or otherwise attached to the outer wall 207 or the base 202. Though other configurations are possible, it may be desirable for the channels 822b to extend generally perpendicularly from the base 202 (e.g., generally parallel to the lifting portion 206).

Various materials may be used to construct the handle support 820, such as metals, composites, and plastics. Considerations in selecting material for the handle support 820 may include, for example, strength of the handle support 820, weight of the bottle jack 200 apart from the handle system 810 (which will, for example, affect the forces acting upon the handle support 820 when the handle support 820 is being used), weight of the handle support 820 (it may, for example, be desirable to minimize the weight of the handle support 820), intended lifespan of the bottle jack 200, intended work environment for the bottle jack 200, and the method of fixing the handle support 820 to the bottle jack 200 (e.g., if welding is used to couple the handle support 820 to the outer wall 207, the material of the handle support 820 must be compatible with the material of the outer wall 207).

The grip member 830 is coupled to the link member 840 in an offset (e.g., generally perpendicular) manner, as shown in FIG. 8a. The grip and link member 830, 840 may be permanently coupled to one another, removably coupled to one another, or may have a unitary construction. In addition, each member 830, 840 is generally rigid and may respectively be a unitary element (e.g., grip member 830 as shown in FIG. 8a), a telescoping element (e.g., link member 840), or multiple separable elements arranged linearly. A handle 832 is at a proximal end of the grip member 830 and may overlay the rigid structure of the grip member 830. The coupling structure 845 may be a pair of protrusions arranged generally linearly and generally perpendicularly to the link member 840, and sized to pass through the access openings 822a and the channels 822b.

Various materials may be used to construct the grip and link members 830, 840. The rigid portions may be constructed, for example, of metals, composites, plastics, and wood, and the handle 832 may be constructed, for example, of rubber and rubberized materials. Hollow metal tube may be particularly desirable for the rigid portions, and considerations in selecting material may include, for example, strength, weight, lifespan, and intended work environment. The coupling structure 845 may be formed unitary with the link member 840, or may be coupled to the link member 840.

As shown in FIG. 8c, to use the bottle jack 200 with the handle system 810, a distal end of the link member 840 interacts with the handle sleeve 205, the telescoping link member 840 is extended, and the user holds the handle 832 and pivots the grip and link members 830, 840 about the handle sleeve 205 to activate the bottle jack 200.

To transport the bottle jack 200 with the handle system 810, the link member 840 is placed between the walls 822, with the protrusions 845 passing through the access openings 822a, and the link member 840 is moved away from the base 202 such that the protrusions 845 pass into the channels 822b above the access openings 822a and temporarily lock the link member 840 to the handle support 820 (FIG. 8a). The user may then carry the bottle jack 200 by the handle 832. The telescoping link member 840 may be retracted (FIGS. 8a and 8b) or extended (FIG. 8c), as desired. When the link member 840 is placed between the walls 822 but the bottle jack 200 is not being actively carried by the handle 832, the protrusions 845 may pass through the channels 822b below the access openings 822a to prevent the link member 840 from separating from the handle support 820.

Those skilled in the art appreciate that variations from the specified embodiments disclosed above are contemplated herein and that the described embodiments are not limiting. The description should not be restricted to the above embodiments, but should be measured by the following claims.

We claim:

1. A handle system for a bottle jack having a base, a handle sleeve, and a lifting portion; the jack handle system comprising:
a first elongate rigid member having proximal and distal ends, the distal end of the first elongate rigid member being configured to interact with the handle sleeve to actuate the jack lifting portion; and
means for temporarily coupling the first elongate rigid member to the bottle jack apart from the handle sleeve such that the first elongate rigid member extends generally perpendicularly to the jack base and generally parallel to the jack lifting portion.

2. The jack handle system of claim 1, further comprising:
a second elongate rigid member having proximal and distal ends; and
a connection member for coupling the first and second elongate rigid members together in a generally linear configuration and an offset configuration.

3. The jack handle system of claim 2, wherein:
the connection member has first, second, and third holes extending therein;
each of the first, second, and third holes is generally perpendicular to each other of the first, second, and third holes;
a keyway extends from the second hole;
a first ramp extends from the keyway to the third hole;
at least one of the first elongate rigid member and the second elongate rigid member includes a retractable pin sized to pass through the keyway; and
the first ramp is configured to retract the retractable pin as the retractable pin passes from the keyway to the third hole.

4. The jack handle system of claim 3, wherein:
the connection member has a fourth hole extending therein;
a center axis of the fourth hole is generally parallel to a center axis of the third hole;
a second ramp extends from the keyway to the fourth hole; and
the second ramp is configured to retract the retractable pin as the retractable pin passes from the keyway to the fourth hole.

5. The jack handle system of claim 4, wherein:
the first elongate rigid member is telescopic and includes a second retractable pin temporarily locking the length of the first elongate rigid member;
the means for temporarily coupling includes a second sleeve having a first opening generally perpendicular to the jack base and a second opening generally perpendicular to the second sleeve first opening;
the second retractable pin has a configuration complementary to a configuration of the second sleeve second opening such that interaction between the second retractable pin and the second sleeve second opening couples the first elongate rigid member to the second sleeve.

6. The jack handle system of claim 4, wherein:
the means for temporarily coupling includes coupling structure defining a passageway extending generally perpendicular to the jack base and an opening generally perpendicular to the passageway; and
the first elongate rigid member includes a protrusion configured to temporarily pass through the coupling structure opening.

7. The jack handle system of claim 6, wherein:
the coupling structure includes a pair of walls spaced apart and extending generally parallel to one another, one of the walls including the coupling structure opening;
a channel extends from an edge of one of the walls to the coupling structure opening; and
the coupling structure opening extends both above and below the channel.

8. The jack handle system of claim 6, wherein:
the coupling structure includes a tubular sleeve; and
the tubular sleeve includes the coupling structure opening.

9. The jack handle system of claim 1, wherein:
the first elongate rigid member is telescopic and includes a retractable pin temporarily locking the length of the first elongate rigid member;
the means for temporarily coupling includes a second sleeve having a first opening generally perpendicular to the jack base and a second opening generally perpendicular to the second sleeve first opening;
the retractable pin has a configuration complementary to a configuration of the second sleeve second opening such that interaction between the retractable pin and the second sleeve second opening couples the first elongate rigid member to the second sleeve.

10. The jack handle system of claim 1, wherein:
the means for temporarily coupling includes coupling structure defining a passageway extending generally perpendicular to the jack base and an opening generally perpendicular to the passageway; and
the first elongate rigid member includes a protrusion configured to temporarily pass through the coupling structure opening.

11. A handle system for a bottle jack having a base, a pivotable handle sleeve, and a lifting portion; the jack handle system comprising:
coupling structure affixed to at least one of the base and the lifting portion, the coupling structure defining a passageway extending generally perpendicular to the jack base and an opening generally perpendicular to the passageway; and
a first elongate rigid member having proximal and distal ends, the distal end of the first elongate rigid member being configured to:
(a) interact with the pivotable handle sleeve to actuate the jack lifting portion; and
(b) pass through the passageway and interact with the opening to couple the first elongate rigid member to the bottle jack apart from the pivotable handle sleeve such that the first elongate rigid member extends generally perpendicularly to the jack base.

12. The jack handle system of claim 11, further comprising:
a second elongate rigid member having proximal and distal ends; and
a connection member for coupling the first and second elongate rigid members together in a generally linear configuration and an offset configuration.

13. The jack handle system of claim 12, wherein:
the connection member has first, second, and third holes extending therein;
each of the first, second, and third holes is generally perpendicular to each other of the first, second, and third holes;
a keyway extends from the second hole;
a first ramp extends from the keyway to the third hole;
at least one of the first elongate rigid member and the second elongate rigid member includes a retractable pin sized to pass through the keyway; and
the first ramp is configured to retract the retractable pin as the retractable pin passes from the keyway to the third hole.

14. The jack handle system of claim 13, wherein:
the connection member has a fourth hole extending therein;
a center axis of the fourth hole is generally parallel to a center axis of the third hole;
a second ramp extends from the keyway to the fourth hole; and
the second ramp is configured to retract the retractable pin as the retractable pin passes from the keyway to the fourth hole.

15. The jack handle of claim 14, wherein the center axis of the third hole and the center axis of the fourth hole are collinear.

16. The jack handle system of claim 15, wherein:
the coupling structure includes a pair of walls spaced apart and extending generally parallel to one another, one of the walls including the coupling structure opening;
a channel extends from an edge of one of the walls to the coupling structure opening; and
the coupling structure opening extends both above and below the channel.

17. The jack handle system of claim 15, wherein:
the coupling structure includes a tubular sleeve; and
the tubular sleeve includes the coupling structure opening.

18. A jack, comprising:
a base;
a pivotable handle sleeve;
a lifting portion;
coupling structure affixed to at least one of the base and the lifting portion, the coupling structure defining a passageway extending generally perpendicular to the base and an opening generally perpendicular to the passageway; and
a first elongate rigid member having proximal and distal ends, the distal end of the first elongate rigid member being configured to:
(a) interact with the pivotable handle sleeve to actuate the lifting portion; and
(b) pass through the passageway and interact with the opening to operatively couple the first elongate rigid member to the lifting portion apart from the pivotable handle sleeve such that the first elongate rigid member extends generally perpendicularly to the base.

19. The jack of claim 18, further comprising:
a second elongate rigid member having proximal and distal ends; and
a connection member for coupling the first and second elongate rigid members together in a generally linear configuration and an offset configuration.
